(19) United States
(12) Patent Application Publication
(10) Pub. No.: US 2012/0254924 A1
(43) Pub. Date: Oct. 4, 2012

(54) METHOD CIRCUIT AND SYSTEM FOR DETECTING A CONNECTION REQUEST WHILE MAINTAINING A LOW POWER MODE

(75) Inventor: Shay Freundlich, Sunnyvale, CA (US)

(73) Assignee: Amimon Ltd, Herzlia (IL)

(21) Appl. No.: 13/391,843

(22) PCT Filed: Apr. 7, 2010
(86) PCT No.: PCT/IB10/51508

§ 371 Date: Jun. 17, 2012

Related U.S. Application Data
(60) Provisional application No. 61/256,251, filed on Oct. 29, 2009.

(51) Int. Cl. H04N 21/61

(52) U.S. Cl. 725/81

(57) ABSTRACT

Disclosed is a method, circuit and system for communication channel scanning by a video transceiver to determine whether a connection is being requested by another video transceiver. Scanning for connections requests may be performed according to two modes: (1) a first (complete) scanning mode, and (2) a second (partial) scanning mode. The information collected and/or recorded during a scanning sequence in the first scanning mode may be used as part of one or more partial scanning sequences performed in the second scanning mode. A scanning sequence in a first scanning mode may be followed by one or more (e.g. one, two, three etc.) scanning sequences in a second scanning mode. There may be provided a scanning circuit for checking for connection requests on one of a set of channels.

### FIELD OF THE INVENTION

The present invention relates generally to the field of communication. More specifically, the present invention relates to a method, circuit and system for detecting a connection request relating to wireless (Radio Frequency—RF) video transmission.

### BACKGROUND

Wireless (Radio Frequency—RF) audio, video and data communication has rapidly evolved over the past century. Each time a new generation of higher performance and higher bandwidth wireless communication equipment is made available, there evolves demand for even higher performance equipment operating at higher data rates. One of the more demanding applications/technology requiring reliable transmission at very high data rates (e.g. gigabits/sec) is high definition video.

Video bearing signals may be generated by various video sources, for example, a computer, a game console, a Video Cassette Recorder (VCR), a Digital-Versatile-Disc (DVD), or any other suitable video source. In many houses, for example, video content is received through cable or satellite links at a Set-Top Box (STB) located at a fixed point. Mobile devices such as laptops, game consoles and mobile phones have also become popular video sources.

In many cases, it may be desired to place a display, screen or projector at a location at a distance of at least a few meters from the video source. This trend is becoming more common as flat-screen displays, e.g., plasma or Liquid Crystal Display (LCD) televisions are hung on walls. Connection of such a display or projector to the video source through cables is generally undesired for aesthetic reasons and/or installation convenience. Thus, wireless transmission of the video signals from the video source to the screen may be preferable. In addition, there is the benefit of freedom in positioning the devices in and out of the room and the advantage of the mobility of handheld devices

There are, however, various challenges associated with RF transmission of video, along with associated audio, from a source to a sink. There are even greater challenges when the video is high definition video. Due to the open and unforeseeable nature (e.g. noise, attenuation) of wireless RF communication, various techniques have been developed and standards adopted in order to improve the probability of successful reception of a transmitted video signal

WHDI—Wireless Home Digital Interface is a new standard for wireless high-definition video connectivity between a video source (e.g. cable box) and video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

Some of the challenges associated with wireless video transmission/reception are due to the fact that the spectrum is segmented into multiple channels, one or more of which may be used and/or changed by the source. The uncertainty of which channel may be used by a transmitter (video source) and/or receiver (video sink) when the transmitted and/or receiver are requesting a connection requires frequency scanning. Frequency scanning is often implemented as part of commercially provided wireless video transmission/reception systems. A WHDI video sink in standby mode, for example, may be required to substantially continuously scan all possible channels useable by a source for a remote connection request. Otherwise, if the source selects a channel which the sink is not scanning, the source and sink may never establish a wireless connection, despite the source requesting one. Frequency scanning during standby mode, either by a source or by a sink, consumes power during standby. Assuming scan time for scanning all the channels/frequencies required is X, and it is performed every Y period of time, and the power used for scanning is P, the average standby power consumption for scanning is P*(X/Y).

The need for mitigating power usage/consumption in electrical devices is self evident. There is thus a need in the field of wireless video communication for improved methods, circuits, devices and systems for transmission and for channel scanning

### SUMMARY OF THE INVENTION

The present invention is a method, circuit and system for communication channel scanning by a video sink transceiver to determine whether a connection is being requested by a video source transceiver. The present invention is also a method, circuit and system for communication channel scanning by a video source transceiver to determine whether a connection is being requested by a video sink transceiver. According to some embodiments of the present invention, scanning for connections requests may be performed according to two modes: (1) a first (complete) scanning mode, and (2) a second (partial) scanning mode. The information collected and/or recorded during a scanning sequence in the first scanning mode may be used as part of one or more partial scanning sequences performed in the second scanning mode. According to further embodiments of the present invention, a scanning sequence in a first scanning mode may be followed by one or more (e.g. one, two, three etc.) scanning sequences in a second scanning mode.

Some embodiments of the present invention may include a scanning circuit for checking for connection requests on one of a set of channels. The scanning circuit may include control logic adapted to intermittently initiate a complete scan sequence and to initiate one or more partial scan sequences in between consecutive complete scan sequences. A partial scan sequences may use information collected during a previous complete scan sequence and/or information collected after a previous partial scan sequence.

According to some embodiments of the present invention, a scanning sequence in a first complete scanning mode may be performed by a circuit (e.g. scanning circuit) integral or otherwise associated with a transceiver (sink transceiver or source transceiver) at first given intervals of time, for example every 10 seconds. During the scan sequence, each of a set of channels/frequencies at which a corresponding transceiver may request a connection may be checked (sequentially or in parallel) for a signal. If a signal is present or found on any of the checked channels/frequencies, the signal may be decoded to determine whether it includes a request for connection to the transceiver with which the scanning circuit is associated. If the scanning circuit finds that a request is present, the scanning sequence may be terminated and a connection may be established. Optionally, in the event the transceiver with which the scanning circuit is associated was in standby mode, the scanning signal may cause the transceiver to activate.

According to further embodiments, if a signal is found on a given scanned channel/frequency, and the signal does not include a connection request to the transceiver, the scanning circuit may record in a data table, such as an “occupied channels table”, that that given channel is occupied. It should be clear to one of skill in the art that alternatively the scanning circuit may record channels/frequencies found not to have signals at all in an “unoccupied channels table”.

If after scanning all the channels, as part of a first mode scan sequence, no connection requests are found, the scan sequence may terminate. Another first mode (i.e. complete) scanning sequence may be performed again after the first given interval of time lapses, unless the transceiver is activated during a second mode scan sequence performed before the next first given intervals.

Second mode (i.e. partial) scan sequences may be performed at a second given interval of time, which second given interval of time may be shorter than the first given interval—for example 3 seconds. Thus, between any two first mode scanning sequences, the scanning circuit may perform one or more second mode scanning sequences. According to some embodiments of the present invention, during the second scanning sequence, the scanning circuit may limit its check to those channels/frequencies which were found to be unoccupied during the previous first mode scanning sequence—that is channels/frequencies not entered into the “occupied channels table” during the previous first mode scanning sequence. It should be clear to one of skill in the art that the table check may conversely be an “unoccupied channels table” listing of channels/frequencies which were found to be unoccupied during the previous first mode scanning sequence, and the scanning circuit may just check channels listed in the table.

During the checking of a channel/frequency (previously found as unoccupied) as part of a second mode scan sequence, the channel/frequency may be checked for a signal. If a signal is found, it may be decoded to check for a relevant connection request. According to some embodiments of the present invention, if during a second mode scan sequence a given channel/frequency is found to have signal without a connection request, the given channel/frequency may be recorded as occupied (e.g. in a data table) and not checked again until the next first mode scan sequence.

If during a second mode scan sequence a checked channel/frequency is found to include a relevant connection request, the transceiver may be activated and a connection established. If no connection requests are found during a second mode scan sequence, the scanning circuit may wait the second given interval of time (e.g. 3 seconds) before performing another second mode scan sequence, unless the first given interval of time (e.g. 10 second) has already lapsed since the previous first mode scanning sequence, in which case the scanning circuit may initiate another first mode scanning sequence.

According to embodiments of the present invention where the first given interval is 10 seconds and the second is 3 seconds, assuming a total of 20 possible channels/frequencies to check and an activity scan period of 100 us for channel and full request decoding of 100 ms, scanning only free channels should take less than 20×100 usec=2 msec, which gives an X/Y value of less than 0.1%—which results in lower standby power consumption. If a channel becomes occupied, but does not contain a connection request, then it is added to the occupied channels list, since new connection request will most probably be performed on a free channel, which will be scanned by the sink every 3 seconds, yielding good response time (less than 3 seconds). If for some reason, the transmission of the connection request is done on a channel that was considered occupied, then the sink will still detect the request during the full (first mode) scan (every 10 seconds). According to this embodiments, the standby power reduction may be upper bounded by 20channel*100 ms/10 seconds=2/10=20%, but in practice, much less than 20 channels will be occupied in the full scan, resulting in lower power consumption (e.g. for 5 occupied channels, the power reduction becomes (4*15*100 us+5*100 ms)/10 s˜=5%).

Embodiments of the present invention may be applied to: (1) a sink in standby mode, scanning for a source's connection request, and (2) a source in standby mode, scanning for a sink's connection request.

According to some embodiments of the present invention, the scanning circuit may include an amplifier and a down converter (e.g. mixer) functionally associated with an adjustable oscillator, for example a voltage controlled oscillator (“VCO”). The scanning circuit may also include a signal detection circuit block adapted to detect and measure signal strength and/or average power of one or more signals/noise which may be present at a carrier frequency being checked/scouted by the circuit.

According to some embodiments of the present invention, the frequency scanning circuit may be used in a spread spectrum and/or channel allocation scheme (e.g. Dynamic Channel Allocation, Dynamic Channel Assignment or Dynamic Frequency Selection) designed to test carrier frequencies from the set of carrier frequencies usable by the transceiver. The frequency scanning circuit may check each carrier channel/frequency in the set of carrier frequencies in a predetermined hopping pattern or some practical order (e.g. from lowest frequency to highest frequency).

According to some embodiments of the present invention, the frequency scanning circuit may be designed as a sub-circuit of a larger circuit containing other sub-circuits (e.g. a data transmitter sub-circuit and/or a data receiver sub-circuit). The larger circuit may be a module designed for wireless communication, for example, a radio frequency integrated circuit (“RFIC”) which may be a data transmitter or a data receiver or a data transceiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a functional block diagram of an exemplary data transmitter/receiver pair according to some embodiments of the present invention where the transmitter (source) includes a frequency scanning circuit block;

FIG. 1B is a functional block diagram of an exemplary data transmitter/receiver pair according to some embodiments of the present invention where the receiver (sink) includes a frequency scanning circuit block and transmits channel availability information to the transmitter;

FIG. 2A is a flow chart including the steps of an exemplary method by which a scanning circuit according to some embodiments of the present invention may check for connection requests using a complete scan sequence;

FIG. 2B is a flow chart including the steps of a further exemplary method by which a scanning circuit according to some embodiments of the present invention may check for connection request using a partial scan sequence; and

FIGS. 3A & 3B are exemplary channel lookup tables according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, DVDs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

It should be understood that some embodiments of the present invention may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video sink. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or sink.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

According to some embodiments of the present invention, there is provided a scanning circuit for checking for a connection request on one of a set of channels. According to further embodiments of the present invention, the scanning circuit may comprise control logic adapted to intermittently initiate a complete scan sequence and to initiate one or more partial scan sequences in between consecutive complete scan sequences. According to further embodiments of the present invention, a partial scan sequence may use information collected during a previous complete scan sequence.

According to some embodiments of the present invention, the scanning circuit may be further adapted to determine whether a checked channel is occupied. According to further embodiments of the present invention, the scanning circuit may be further adapted to update a record in a data table regarding channel availability. According to some embodiments of the present invention, the control logic may be further adapted to initiate a partial scan sequence including channels determined to be unoccupied. According to further embodiments of the present invention, the control logic may be further adapted to initiate a partial scan sequence excluding channels determined to be occupied.

According to some embodiments of the present invention, the control logic may be further adapted to initiate a partial scan sequence using information collected during a previous partial scan sequence.

According to some embodiments of the present invention, the scanning circuit may be further adapted to terminate a scan sequence when a connection request is detected. According to further embodiments of the present invention, the scanning circuit may be further adapted to be integral with or functionally associated with a transceiver. According to further embodiments of the present invention, the scanning circuit may be further adapted to activate the transceiver from a standby mode.

According to some embodiments of the present invention, there is provided a source transceiver comprising a scanning circuit for checking for a connection request on one of a set of channels. According to further embodiments of the present invention, the scanning circuit may comprise control logic adapted to intermittently initiate a complete scan sequence and to initiate one or more partial scan sequences in between consecutive complete scan sequences. A partial scan sequence may use information collected during a previous complete scan sequence.

According to some embodiments of the present invention, the source transceiver may be further adapted to determine whether a checked channel is occupied. According to further embodiments of the present invention, the source transceiver may be further adapted to update a record in a data table regarding channel availability. According to some embodiments of the present invention, the control logic may be further adapted to initiate a partial scan sequence including channels determined to be unoccupied. According to some embodiments of the present invention, the control logic may be further adapted to initiate a partial scan sequence excluding channels determined to be occupied. According to some embodiments of the present invention, the control logic may be further adapted to initiate a partial scan sequence using information collected during a previous partial scan sequence.

According to some embodiments of the present invention, the source transceiver may be further adapted to terminate a scan sequence when a connection request is detected. According to further embodiments of the present invention, the source transceiver may be further adapted to be integral with or functionally associated with a transmitter. According to further embodiments of the present invention, the source transceiver may be further adapted to activate the transmitter from a standby mode. According to further embodiments of the present invention, the source transceiver may be further adapted to transmit establish a connection with a functionally associated sink transceiver.

According to some embodiments of the present invention, there is provided a sink transceiver comprising a scanning circuit for checking for a connection request on one of a set of channels. According to further embodiments of the present invention, the scanning circuit may comprise control logic adapted to intermittently initiate a complete scan sequence and to initiate one or more partial scan sequences in between consecutive complete scan sequences. According to further embodiments of the present invention, a partial scan sequence may use information collected during a previous complete scan sequence.

According to some embodiments of the present invention, the sink transceiver may be further adapted to determine whether a checked channel is occupied. According to further embodiments of the present invention, the sink transceiver may be further adapted to update a record in a data table regarding channel availability. According to further embodiments of the present invention, the control logic may be further adapted to initiate a partial scan sequence including channels determined to be unoccupied. According to some embodiments of the present invention, the control logic may be further adapted to initiate a partial scan sequence excluding channels determined to be occupied. According to further embodiments of the present invention, the control logic may be further adapted to initiate a partial scan sequence using information collected during a previous partial scan sequence. According to further embodiments of the present invention, the sink transceiver may be further adapted to terminate a scan sequence when a connection request is detected. According to further embodiments of the present invention, the sink transceiver may be further adapted to be integral with or functionally associated with a transmitter. According to further embodiments of the present invention, the sink transceiver may be further adapted to activate the transmitter from a standby mode. According to further embodiments of the present invention, the sink transceiver may be further adapted to transmit establish a connection with a functionally associated source transceiver.

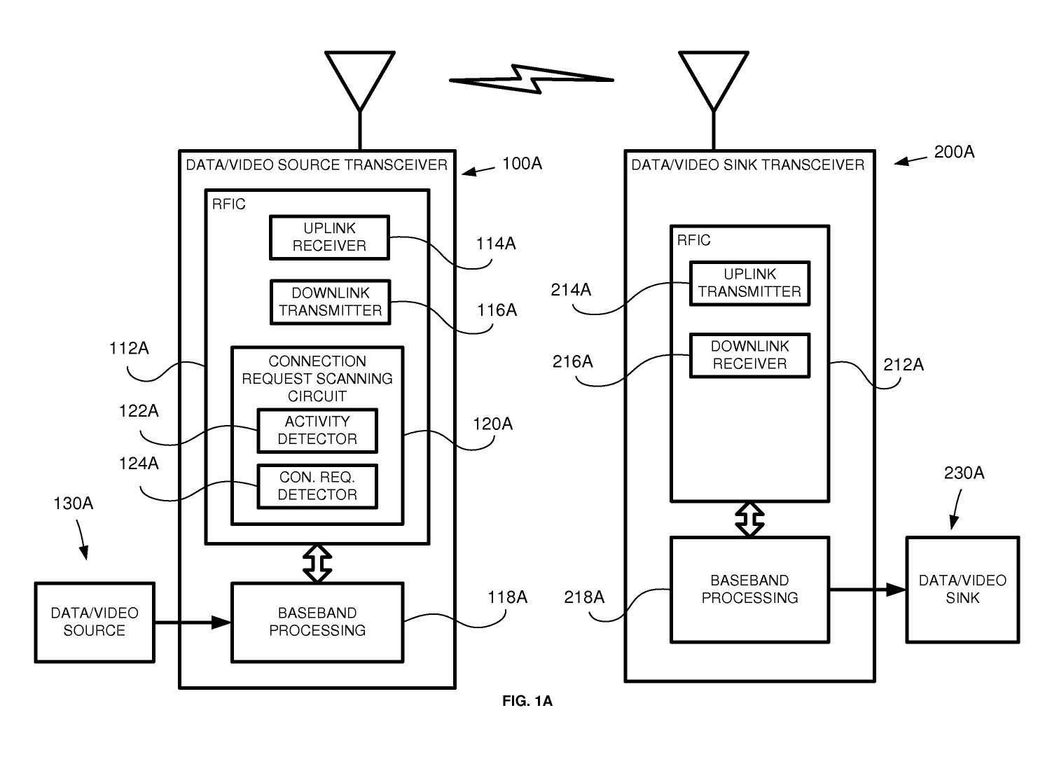

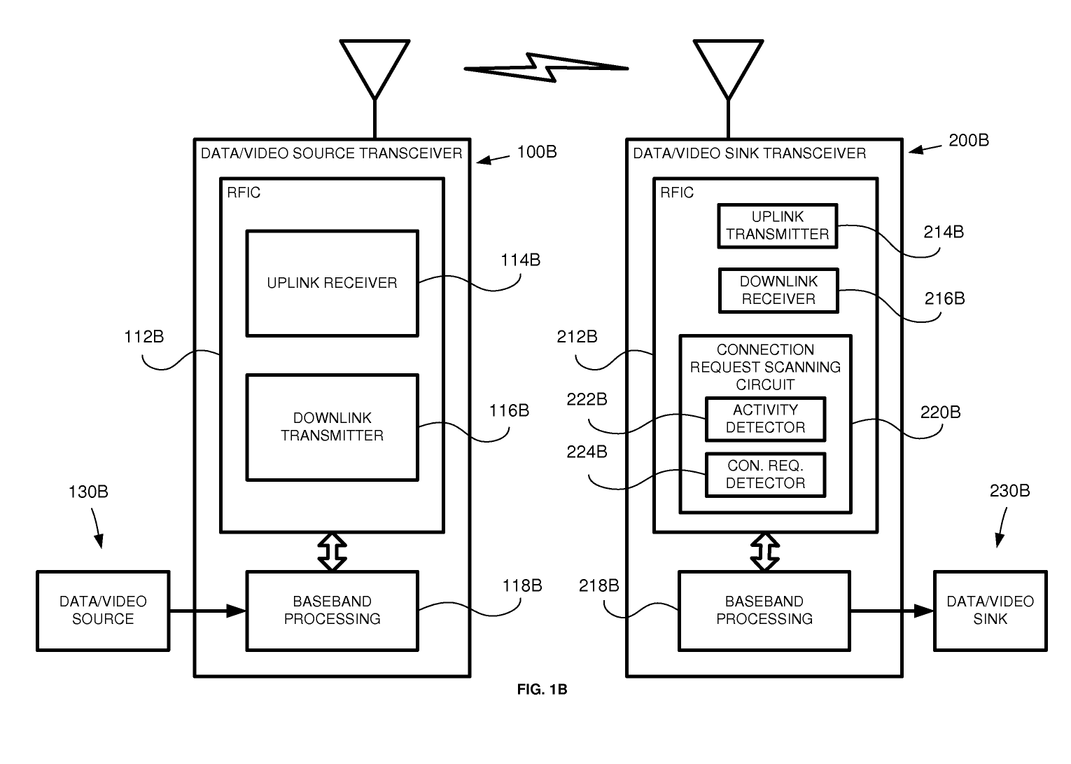

Now turning to FIG. 1A there is shown a functional block diagram of an exemplary data transmitter/receiver (i.e. transceiver) pair according to some embodiments of the present invention where the data source transceiver includes a frequency scanning circuit block.

According to some embodiments of the present invention, prior to a source transceiver (100A) transmitting data to a functionally associated sink transceiver (200A) over a given channel centered on a given carrier frequency, a functionally associated connection request scanning circuit (120A) may check the given channel for a connection request and/or availability. The connection request scanning circuit (120A) may select which channels to scan/check based on either signaling from control logic associated with the transmitter or based on internal control logic adapted to implement a scanning sequence or algorithm.

According to some embodiments of the present invention, the connection request scanning circuit (120A) may contain an activity detector (122A) and a connection request detector (124A). According to further embodiments of the present invention, the connection request scanning circuit (120A) may adjust its oscillator/synthesizer to a selected channel and may receive signals and/or noise on the channel while scanning the channel for a connection request and/or data transmission availability. The oscillator may be dedicated to the connection request scanning circuit (120A) and may be inductively decoupled from other oscillators on the integrated circuit.

According to some embodiments of the present invention, the connection request scanning circuit (120A) may indicate an ID of the available channel to a downlink transmitter (116A) over one or more signaling lines or links. According to other embodiments of the present invention, the connection request scanning circuit (120A) may update a record in a channel table with one or more channel parameters (e.g. channel ID, sending a connection request, timestamp of last monitoring, channel availability, channel quality measurement, etc.) associated with or indicating channel availability and/or suitability for transmission.

Now turning to FIG. 1B there is shown a functional block diagram of an exemplary data transmitter/receiver (i.e. transceiver) pair according to some embodiments of the present invention where the data sink transceiver includes a frequency scanning circuit block and transmits channel availability information to the data source transceiver.

According to some embodiments of the present invention, a connection request scanning circuit (220B) on the sink transceiver (200B), may indicate an ID of an available channel to a functionally associated source transceiver (100B) via an uplink transmitter (214B).

According to other embodiments of the present invention, the connection request scanning circuit (220B) may update a record in a channel table with one or more channel parameters (e.g. channel ID, sending a connection request, timestamp of last monitoring, channel availability, channel quality measurement, etc.) associated with or indicating channel availability and/or suitability for transmission. According to further embodiments of the present invention, the parameters may be sent to the source transceiver (100B) over the uplink transmitter (214B).

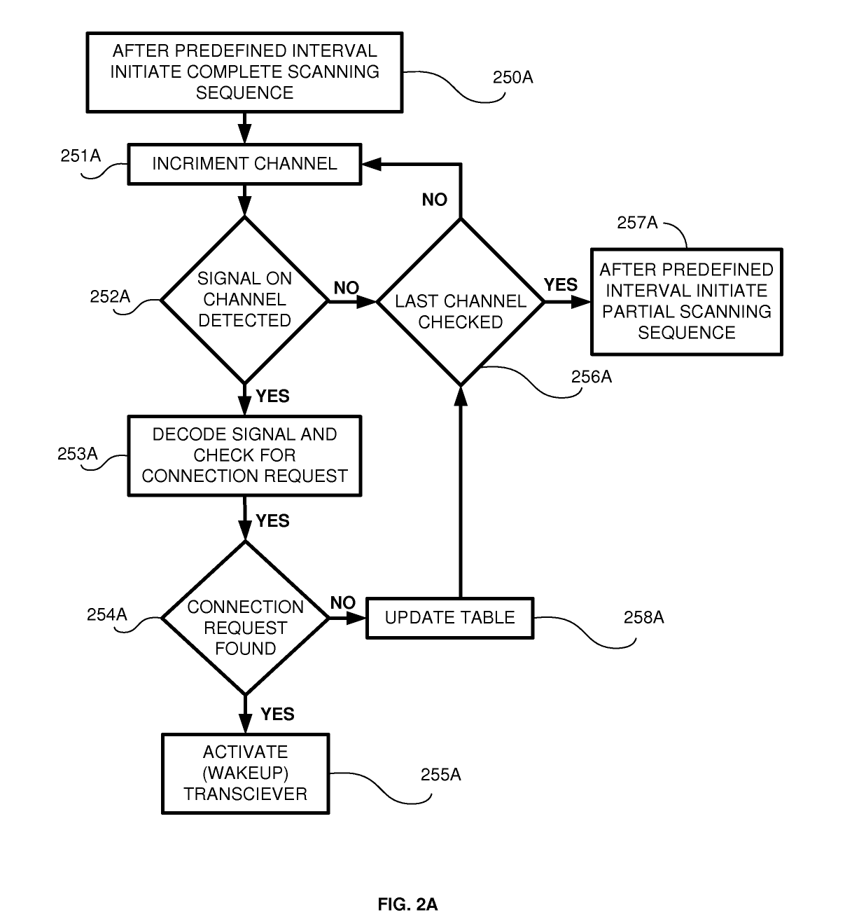

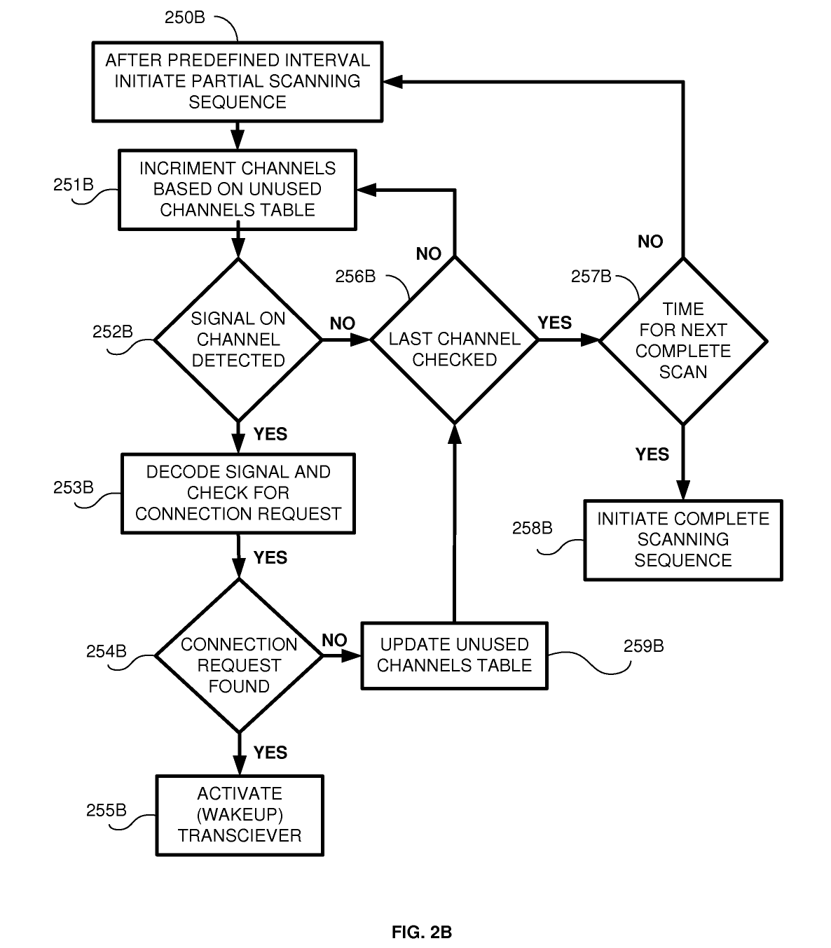

Now turning to FIG. 2A there is shown a flow chart including the steps of an exemplary method by which a scanning circuit according to some embodiments of the present invention may check for connection requests using a complete scan sequence.

According to some embodiments of the present invention, after a predefined interval, the scanning circuit may initiate (250A) a complete scanning sequence and increment (251A) a channel value corresponding to an initial channel number. According to further embodiments of the present invention, if a signal is not detected on the channel (252A) and there is an additional channel to check (256A), the scanning circuit may increment (251A) the channel value corresponding to the additional channel.

According to some embodiments of the present invention, when a signal is detected on a scanned channel (252A), the scanning circuit may decode the signal and check for a connection request (253A). According to further embodiments of the present invention, if a connection request is found (254A), the scanning circuit may activate (e.g. wakeup from a low-power mode) a functionally associated or otherwise integral transceiver (255A). If a connection request is not found on a decoded signal (254A), the scanning circuit may update a channel lookup table (258A) with data corresponding to the decoded channel (i.e. channel availability).

According to some embodiments of the present invention, if there is no additional channel to check (256A), the scanning circuit may initiate a partial scanning sequence after a predefined interval (257A).

Now turning to FIG. 2B there is shown a flow chart including the steps of a further exemplary method by which a scanning circuit according to some embodiments of the present invention may check for connection request using a partial scan sequence.

According to some embodiments of the present invention, after a predefined interval, the scanning circuit may initiate (250B) a partial scanning sequence and increment (251B) a channel value based on a functionally associated or otherwise integral unused channel lookup table. According to further embodiments of the present invention, if a signal is not detected on the channel (252B) and there is an additional channel to check (256B), the scanning circuit may increment (251B) the channel value corresponding to the next channel in the channel unused lookup table.

According to some embodiments of the present invention, when a signal is detected on a scanned channel (252B), the scanning circuit may decode the signal and check for a connection request (253B). According to further embodiments of the present invention, if a connection request is found (254B), the scanning circuit may activate (e.g. wakeup from a low-power mode) a functionally associated or otherwise integral transceiver (255B). If a connection request is not found on a decoded signal (254B), the scanning circuit may update the unused channel lookup table (259B) with data corresponding to the decoded channel (i.e. channel availability).

According to some embodiments of the present invention, if there is no additional channel to check (256B), the scanning circuit may initiate a partial scanning sequence after a predefined interval (257A). According to further embodiments of the present invention when it is time for the next complete scan (257B), the scanning circuit may initiate a complete scanning sequence (258B).

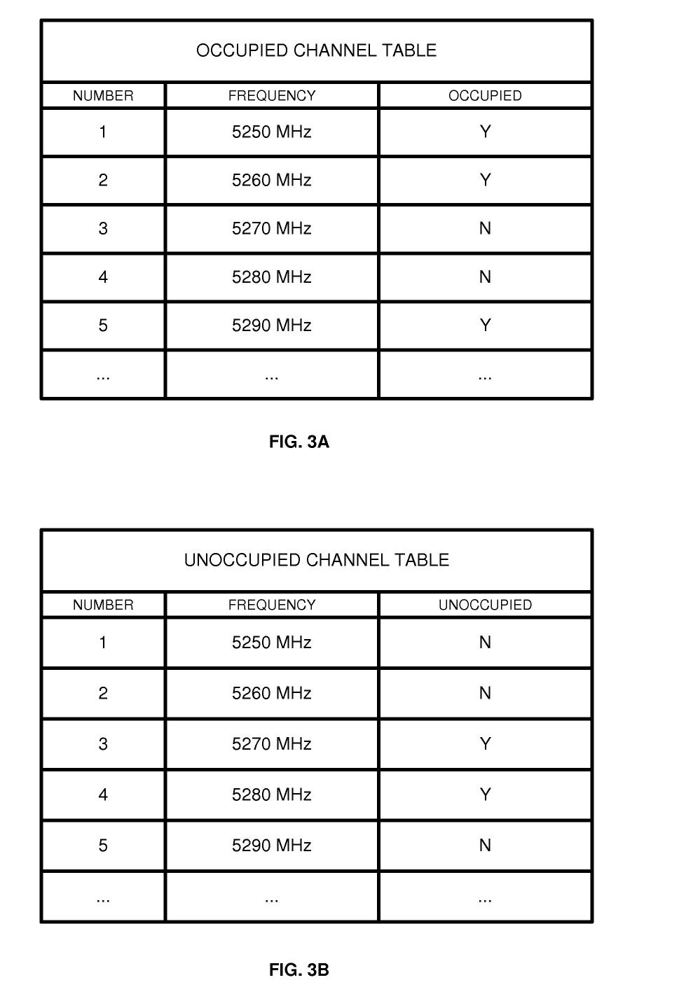

Now turning to FIGS. 3A & 3B there are shown exemplary channel lookup tables according to some embodiments of the present invention.

According to some embodiments of the present invention, a connection request scanning circuit may update a record in a channel table with one or more channel parameters (e.g. channel ID, channel availability, channel quality measurement, etc.) associated with or indicating channel availability and/or suitability for transmission. During a complete or partial scanning sequence, if a connection request is not found on a decoded signal, the scanning circuit may update the channel lookup table with data corresponding to the decoded channel (i.e. channel availability). According to further embodiments of the present invention, the scanning circuit may update an occupied channel table (FIG. 3A) when a scanned channel is not available. During a partial scanning sequence, the scanning circuit may not scan occupied channels for connection requests.

According to some embodiments of the present invention, the scanning circuit may initiate a partial scanning sequence by incrementing a channel value corresponding to the first channel on the unoccupied channel table (FIG. 3B). If a signal is not detected on the channel, the scanning circuit may increment the channel value corresponding to the next channel in the unoccupied channel table.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A scanning circuit for checking for a connection request on one of a set of channels, said scanning circuit comprising:
control logic adapted to intermittently initiate a complete scan sequence and to initiate one or more partial scan sequences in between consecutive complete scan sequences, wherein a partial scan sequence uses information collected during a previous complete scan sequence.

2. The scanning circuit according to claim 1, further adapted to determine whether a checked channel is occupied.

3. The scanning circuit according to claim 2, further adapted to update a record in a data table regarding channel availability.

4. The scanning circuit according to claim 3, wherein said control logic is further adapted to initiate a partial scan sequence including channels determined to be unoccupied.

5. The scanning circuit according to claim 3, wherein said control logic is further adapted to initiate a partial scan sequence excluding channels determined to be occupied.

6. The scanning circuit according to claim 1, wherein said control logic is further adapted to initiate a partial scan sequence using information collected during a previous partial scan sequence.

7. The scanning circuit according to claim 1, further adapted to terminate a scan sequence when a connection request is detected.

8. The scanning circuit according to claim 7, further adapted to be integral with or functionally associated with a transceiver.

9. (canceled)

10. A source transceiver comprising a scanning circuit for checking for a connection request on one of a set of channels, said scanning circuit comprising:
control logic adapted to intermittently initiate a complete scan sequence and to initiate one or more partial scan sequences in between consecutive complete scan sequences, wherein a partial scan sequence uses information collected during a previous complete scan sequence.

11. The source transceiver according to claim 10, further adapted to determine whether a checked channel is occupied.

12. The source transceiver according to claim 11, further adapted to update a record in a data table regarding channel availability.

13. (canceled)

14. (canceled)

15. The source transceiver according to claim 10, wherein said control logic is further adapted to initiate a partial scan sequence using information collected during a previous partial scan sequence.

16. The source transceiver according to claim 10, further adapted to terminate a scan sequence when a connection request is detected.

17. (canceled)

18. (canceled)

19. (canceled)

20. A sink transceiver comprising a scanning circuit for checking for a connection request on one of a set of channels, said scanning circuit comprising:
control logic adapted to intermittently initiate a complete scan sequence and to initiate one or more partial scan sequences in between consecutive complete scan sequences, wherein a partial scan sequence uses information collected during a previous complete scan sequence.

21. The sink transceiver according to claim 20, further adapted to determine whether a checked channel is occupied.

22. The sink transceiver according to claim 21, further adapted to update a record in a data table regarding channel availability.

23. The sink transceiver according to claim 22, wherein said control logic is further adapted to initiate a partial scan sequence including channels determined to be unoccupied.

24. The sink transceiver according to claim 22, wherein said control logic is further adapted to initiate a partial scan sequence excluding channels determined to be occupied.

25. The sink transceiver according to claim 20, wherein said control logic is further adapted to initiate a partial scan sequence using information collected during a previous partial scan sequence.

26. The sink transceiver according to claim 20, further adapted to terminate a scan sequence when a connection request is detected.

27. (canceled)

28. (canceled)

29. (canceled)
